(19) United States
(12) Patent Application Publication
(10) Pub. No.: US 2017/0341052 A1
(43) Pub. Date: Nov. 30, 2017

(54) ADSORPTION FILTER

(71) Applicant: KURARAY CO., LTD., Kurashiki-shi, Okayama (JP)

(72) Inventors: Hiroe YOSHINOBU, Okayama (JP); Tetsuya HANAMOTO, Okayama (JP)

(73) Assignee: KURARAY CO., LTD., Kurashiki-shi (JP)

(21) Appl. No.: 15/527,965

(22) PCT Filed: Nov. 10, 2015
(86) PCT No.: PCT/JP2015/081583

§ 371 Date: May 18, 2017

(30) Foreign Application Priority Data
Nov. 19, 2014 (JP) 2014-234155

(51) Int. Cl. B01J 20/20; B01J 20/28; B01D 39/16; C02F 1/28

(52) U.S. Cl. CPC B01J 20/20; C02F 2201/006; C02F 1/288; C02F 1/283; B01J 20/2803; B01J 20/28023; B01J 20/28004; B01D 39/1607; B01D 2257/70; B01D 2257/2064; B01D 2239/125; B01D 2239/1241; B01D 2239/086; B01D 39/1646; B01D 2257/90

(57) ABSTRACT

The present invention relates to an adsorption filter including activated carbon and a fibrillated fibrous binder, in which the activated carbon has a 0% particle diameter (D0) of 10 μm or more in a volume-based cumulative particle-size distribution and has a 50% particle diameter (D50) of 90 to 200 μm in the volume-based cumulative particle-size distribution; the fibrillated fibrous binder has a CSF value of 10 to 150 mL; and the adsorption filter includes 4 to 8 parts by mass of the fibrillated fibrous binder relative to 100 parts by mass of the activated carbon.

### TECHNICAL FIELD

The present invention relates to an adsorption filter including activated carbon.

### BACKGROUND ART

In recent years, safety and hygienic concerns have increased with regard to water quality of tap water, and removal of harmful substances contained in tap water, such as free residual chlorine, VOC (volatile organic compounds) such as trihalomethanes, agricultural chemicals, and musty odors, is desired.

In particular, chlorine that is used in tap water or the like for preventing propagation of bacteria is not a nontoxic substance, and when hair or skin is washed with tap water having a high residual chlorine concentration, the protein of the hair or skin may be denatured and damaged.

Hitherto, in order to remove these harmful substances, an adsorption molded body obtained by entangling a fibrillated fibrous binder with granular activated carbon is used as a filter.

For example, Patent Literature 1 discloses a molded adsorption body in which a filter material mainly composed of activated carbon is molded with a fibrous binder, wherein the activated carbon is fine-particle activated carbon having a volume-based mode diameter of 20 μm or more and 100 μm or less, and the fibrous binder is mainly composed of a fiber material having a freeness of 20 mL or more and 100 mL or less by fibrillation.

When powdery activated carbon having a small particle diameter is molded with a fibrous binder having a low freeness as in the molded adsorption body disclosed in Patent Literature 1, the moldability is improved (uniform molding is facilitated), and also a filter having high adsorption performance and stable product quality is obtained. However, a problem has been found out that, when a fine powder is included in the filter, an increase in pressure loss occurs in addition to a decrease in molded body strength, and moreover, clogging of the filter is liable to occur. If clogging occurs, problems arise such as not being capable of obtaining a sufficient water flow rate, breakage caused by a load of water pressure imposed on the filter, and outflow of water not purified yet or a filter material from a broken site.

Therefore, there is a demand for an adsorption filter which is made of powdery activated carbon and a binder and which retains excellent filtration capability and suitable strength, is less liable to cause clogging, and has low resistance.

### CITATION LIST

### Patent Literature

Patent Literature 1: Japanese Unexamined Patent Publication No. 2011-255310

### SUMMARY OF INVENTION

In view of the aforementioned problems, an object of the present invention is to provide an adsorption filter that satisfies the aforementioned demand.

As a result of eager studies, the present inventors have found out that the aforementioned problems are solved by an activated carbon molded body having a configuration described below, and have completed the present invention by making further studies based on these findings.

In other words, an adsorption filter according to one aspect of the present invention includes activated carbon and a fibrillated fibrous binder, wherein the activated carbon has a 0% particle diameter (D0) of 10 μm or more in a volume-based cumulative particle-size distribution and has a 50% particle diameter (D50) of 90 to 200 μm in the volume-based cumulative particle-size distribution; the fibrillated fibrous binder has a CSF value of 10 to 150 mL; and the adsorption filter includes 4 to 8 parts by mass of the fibrillated fibrous binder relative to 100 parts by mass of the activated carbon.

The present invention can provide an adsorption filter adsorption filter having an excellent water-passing property and high adsorption performance, in particular, having excellent filtration capability to remove free residual chlorine, agricultural chemicals, and mold odors, as well as having difficulty in causing clogging and having low resistance.

### BRIEF DESCRIPTION OF DRAWINGS

FIG. 1 shows one example of a grinder for grinding a molded body itself of an adsorption filter according to the present embodiment by rotation.

FIG. 2 is a graph showing a particle size distribution of activated carbon samples in Examples and Comparative Examples.

### DESCRIPTION OF EMBODIMENTS

Hereafter, embodiments according to the present invention will be specifically described; however, the present invention is not limited to these embodiments.

An adsorption filter according to the present embodiment includes activated carbon and a fibrillated fibrous binder, wherein the activated carbon has a 0% particle diameter (D0) of 10 μm or more in a volume-based cumulative particle-size distribution and has a 50% particle diameter (D50) of 90 to 200 μm in the volume-based cumulative particle-size distribution; the fibrillated fibrous binder has a CSF value of 10 to 150 mL; and the adsorption filter includes 4 to 8 parts by mass of the fibrillated fibrous binder relative to 100 parts by mass of the activated carbon.

Such a configuration can provide an adsorption filter having an excellent water-passing property and high adsorption performance, in particular, having excellent filtration capability to remove free residual chlorine, agricultural chemicals, and mold odors, as well as having difficulty in causing clogging and having low resistance. Further, the filter has improved strength, suppresses an increase in pressure loss, and is excellent in productivity as well.

This is considered to be due to the following reasons. If a fine powder of activated carbon having a small particle diameter is included, a filter to be formed has low strength, and an increased pressure loss. Therefore, removal of such a fine powder makes clogging less liable to occur, increases molded body strength, and can suppress a pressure loss.

In the present embodiment, powdery activated carbon having a 0% particle diameter (D0) of 10 μm or more in a volume-based cumulative particle-size distribution and having a 50% particle diameter (D50) of 90 to 200 μm in the volume-based cumulative particle-size distribution is used.

If the D0 of the activated carbon is less than 10 μm, clogging may occur in the filter, making the life of the filter be short. Also, the fine powder may be mingled into the processed water. There is no particular upper limit to the D0; however, the D0 is more preferably 60 μm or less from the viewpoint of being able to exhibit high adsorption performance without lowering contact efficiency.

Further, if the D50 of the activated carbon is less than 90 μm, resistance to passing water increases, and also clogging may occur in the filter. In contrast, if the D50 exceeds 200 μm, there is a possibility that sufficient adsorption performance may not be obtained due to lowering of contact efficiency, and in particular, the filter tends to be poor in dechlorination performance. A range of the D50 of the activated carbon is more preferably from 100 to 180 μm, still more preferably from 110 to 150 μm.

In the present embodiment, the numerical values of the above D0 and D50 are values measured by laser diffraction/scattering method, and the measurement is carried out, for example, with a wet particle size distribution measuring apparatus (MICROTRAC MT3300EX II) manufactured by Nikkiso Co., Ltd., or the like.

In the present embodiment, two or more different kinds of powdery activated carbon may be included as long as the aforementioned ranges of D0 and D50 are satisfied. That is, a final mixture obtained by mixing two or more different kinds of powdery activated carbon is usable when the above D0 and D50 are satisfied.

The activated carbon used in the adsorption filter of the present embodiment is not particularly limited, and commercially available activated carbon can be used. Alternatively, the activated carbon may be obtained, for example, by carbonizing and/or activating a carbonaceous material. When the carbonization is necessary, the carbonization may be typically carried out, for example, at a temperature of about 400 to 800° C., preferably about 500 to 800° C., and more preferably about 550 to 750° C., in the absence of oxygen or air. The activation may be carried out by any of gas activation method or chemical activation method. The gas activation method and the chemical activation method may be used in combination. In particular, when the filter is to be used for purification of water, the gas activation method is preferable because of leaving a less amount of residual impurities. The gas activation method may be carried out typically, for example, by allowing a carbonized carbonaceous material to react with an activation gas (for example, water vapor, carbon dioxide gas, or the like) at a temperature of about 700 to 1100° C., preferably about 800 to 980° C., and more preferably about 850 to 950° C. In consideration of safety and reactivity, the activation gas is preferably a water-vapor-containing gas containing 10 to 40% by volume of water vapor. The activation time and temperature-raising speed are not particularly limited and can be suitably selected depending on the kind, form, and size of a carbonaceous material to be selected.

The carbonaceous material is not particularly limited. Examples of the carbonaceous material include plant-series carbonaceous materials (for example, materials derived from plants, such as wood, sawdust, charcoal, fruit shell such as coconut shell or walnut shell, fruit seed, by-product of pulp production, lignin, and waste molasses), mineral-series carbonaceous materials (for example, materials derived from minerals, such as peat, lignite, brown coal, bituminous coal, anthracite coal, coke, coal tar, coal tar pitch, petroleum distillation residue, and petroleum pitch), synthetic resin-series carbonaceous materials (for example, materials derived from synthetic resins, such as a phenolic resin, polyvinylidene chloride, and acrylic resin), and natural fiber-series carbonaceous materials (for example, materials derived from natural fibers, such as natural fiber (e.g., cellulose) and regenerated fiber (e.g., rayon)). These carbonaceous materials may be used alone or in combination of two or more thereof. Among these carbonaceous materials, coconut shell or phenolic resin is preferred in view of the fact that such a material easily forms micropores that are involved in the performance of adsorbing volatile organic compounds defined in JIS S3201(2010).

After activation, the activated carbon may be washed for removing ash components or chemical agents, particularly when a plant-series carbonaceous material such as coconut shell or a mineral-series carbonaceous material is used. For the washing, a mineral acid or water is used. The mineral acid is preferably hydrochloric acid having high washing efficiency.

The powdery activated carbon of the present embodiment may have a BET specific surface area, as calculated by nitrogen adsorption method, of about 600 to 2000 m²/g, and for example, about 800 to 1800 m²/g, preferably about 900 to 1500 m²/g, and more preferably about 1000 to 1300 m²/g. If the specific surface area is excessively large, it is difficult to adsorb volatile organic compounds. If the specific surface area is excessively small, the performance of removing volatile organic compounds, CAT, and 2-MIB lowers.

If the adsorption capacity of the activated carbon is excessively small, it cannot be stated that the activated carbon possesses sufficient adsorbability. If the adsorption capacity is excessively large, the activated carbon is in an excessively activated state and has an increased pore size, and the absorption performance of harmful substances tends to be poor. Therefore, the adsorption capacity of the activated carbon of the present embodiment, though depending on the purpose of use, is preferably about 25 to 60% by mass in terms of the benzene adsorption amount (saturated adsorption amount when aeration is made at a concentration of 1/10 of the saturated benzene concentration at 20° C.).

The powdery activated carbon satisfying the above ranges of D0 and D50 can be prepared, for example, by grinding granular activated carbon with a grinding machine such as a ball mill or a roll mill, sieving the fine powder as necessary with a vibration sieve to obtain crude grains, followed by wet classification or dry classification.

As the wet classification method, it is possible to use a general elutriation technique utilizing a phenomenon such that the sedimentation velocity of particles in water depends on the particle size. Specifically, for example, it is possible to use a method of dispersing activated carbon containing fine powders in water, thereafter using gravity filtration, vacuum filtration, or a centrifugal machine to move particles by large gravitational acceleration, and collecting the activated carbon in a slurry state or as a cake adhering to a wall surface of a rotor. Such classification may be repeatedly carried out instead of being carried out only once, whereby the classification effect may be further enhanced.

Examples of the dry classification method include a forced vortex centrifugation method in which a rotor is provided in an inside of an apparatus to allow a centrifugal force to act on activated carbon particles so as to allow the particles to exert a fluid resistance force, and a semifree vortex centrifugation method in which a swirling flow of air is made without having a rotor in an inside of an apparatus so as to allow the particles to exert a fluid resistance force.

The wet and dry classification methods are repeated until a predetermined value of D0 is attained by confirming a particle-size distribution of the obtained activated carbon. These classification methods may be repeatedly carried out by a single method or may be repeatedly carried out by different methods in combination. In the present embodiment, there is a need to obtain activated carbon having a small particle size, so that any of these methods may be adopted. However, in the wet classification, as particles to be classified have a smaller size, the sedimentation velocity of the particles in water decreases, so that productivity may be lowered or a drying step may be necessary. For this reason, it is preferable that the dry classification method is adopted and the classification method is repeatedly carried out until a predetermined value of D0 is attained.

The adsorption filter of the present embodiment includes 4 to 8 parts by mass of the fibrillated fibrous binder relative to 100 parts by mass of the activated carbon. If the amount of the fibrillated fibrous binder is less than 4 parts by mass, sufficient strength may not be obtained, and a molded body may not be formed. If the amount of the fibrillated fibrous binder exceeds 8 parts by mass, the adsorption performance may be poor. More preferably, 4.5 to 6 parts by mass of the fibrillated fibrous binder is blended relative to 100 parts by mass of the activated carbon.

The fibrillated fibrous binder used in the present embodiment is not particularly limited as long as the binder can be fibrillated to entangle and shape powdery activated carbon, and a wide variety of binders including synthetic binders and natural binders can be used. Examples of such fibrillated fibrous binders include acrylic fibers, polyethylene fibers, polypropylene fibers, polyacrylonitrile fibers, cellulose fibers, nylon fibers, and aramid fibers. Among these, acrylic fibers, cellulose fibers, and the like are suitably used in view of permitting easy fibrillation and high effect of binding the activated carbon.

Two or more kinds of these fibers can be used in combination. As a particularly preferable embodiment, a mixed body of an acrylic fiber and a cellulose fiber can be used as the fibrillated fibrous binder. This is considered to enhance the molded body density and the molded body strength to a further extent.

In the present embodiment, the water-passing property of the fibrillated fibrous binder is about 10 to 150 mL in terms of a CSF value. In the present embodiment, the CSF value is a value obtained by measurement in accordance with JIS P8121 “Pulps-Determination of Drainability” Canadian Standard freeness method. The CSF value can be adjusted by fibrillating the fibrous binder.

If the fibrillated fibrous binder has a CSF value of less than 10 mL, the water-passing property is not obtained, so that the molded body strength is lowered, and the pressure loss increases. In contrast, if the CSF value exceeds 150 mL, the powdery activated carbon cannot be sufficiently retained, so that the molded body strength is lowered, and the adsorption performance is poor.

Production of the adsorption filter of the present embodiment is carried out by an arbitrary method, and is not particularly limited. In view of efficient production, slurry suction method is preferable.

More specifically, for example, a cylindrical filter can be obtained by a production method that includes a slurry preparation step of preparing a slurry by dispersing the powdery activated carbon and the fibrous binder in water; a vacuum filtration step of filtering the slurry while performing suction to give a premolded body; a drying step of drying the premolded body to give a dried molded body; and a grinding step of grinding an outer surface of the molded body.

(Slurry Preparation Step)

In the slurry preparation step, a slurry is prepared in which the powdery activated carbon and the fibrillated fibrous binder are dispersed in water so that the resulting slurry may contain 4 to 8 parts by mass of the fibrillated fibrous binder relative to 100 parts by mass of the activated carbon and have a solid component concentration of 0.1 to 10% by mass (preferably 1 to 5% by mass). If the solid component concentration of the slurry is excessively high, the dispersion tends to be nonuniform, and mottles are liable to be generated in the molded body. In contrast, if the solid component concentration is excessively low, the molding time is prolonged to not only lower the productivity, but also to increase the density of the molded body, so that clogging is liable to occur due to trapping of the turbidity components.

(Vacuum Filtration Step)

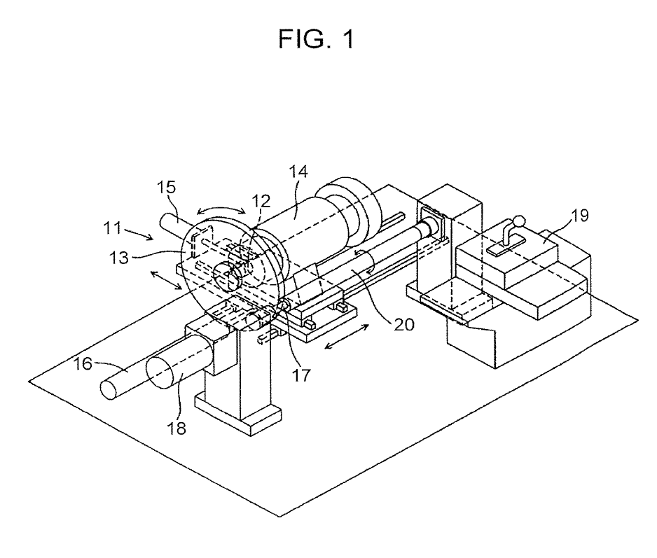

In the vacuum filtration step, a forming die having a large number of holes is placed into the slurry, and the slurry is molded by performing filtration while sucking the slurry from the inside of the forming die. As the forming die, for example, a conventional die may be used. For example, a die as depicted in FIG. 1 of Japanese Patent No. 3516811 may be used. The suction method may be a conventional method, for example, a method using a suction pump.

(Drying Step)

In the drying step, the premolded body obtained in the vacuum filtration step is removed from the die and dried by a drier or other means to give a molded body.

The drying temperature is, for example, about 100 to 150° C. (preferably about 110 to 130° C.). The drying time is, for example, about 4 to 24 hours (preferably about 8 to 16 hours). If the drying temperature is too high, degeneration or melting of the fibrillated fibrous binder is liable to occur, so that the resulting molded body tends to have low filtration performance or low strength. If the drying temperature is too low, the drying time tends to be prolonged, or the drying tends to become insufficient.

(Grinding Step)

The grinding step is not particularly limited as long as an outer surface of the dried molded body can be ground (or polished), and a conventional grinding method may be used; however, from the viewpoint of uniform grinding, a method using a grinding machine that grinds the molded body by rotating the molded body itself is preferably used.

FIG. 1 is one example of a grinding machine for grinding the molded body by rotating the molded body itself. This grinding machine 11 is provided with a disk-shaped grindstone 13 (the grindstone having a particle size of 90 to 125 μm) for grinding a molded body 20, the grindstone 13 being attached to a rotation shaft 12; a rotation shaft 17 for rotatably fixing the molded body 20; and a control panel 19. The disk-shaped grindstone 13 is rotatable by a motor 14 and is relatively movable forward and backward by an air cylinder 15 having a fixed position so that the disk-shaped grindstone 13 can be brought into contact with the molded body 20. The disk-shaped grindstone 13 is also movable together with the rotation shaft 12 along a longitudinal or axial direction of the molded body 20 by an air cylinder 16 having a fixed position. For this reason, the disk-shaped grindstone 13 is brought into contact with an outer surface of the molded body 20 to grind the outer surface of the molded body and is movable on the outer surface of the molded body along the longitudinal direction of the molded body to uniformly grind the outer surface of the molded body in the longitudinal direction. In contrast, the rotation shaft 17 is also rotatable, by a motor 18, in a direction opposite to the direction of rotation of the disk-shaped grindstone. This grinding machine rotates not only the molded body but also the disk-shaped grindstone, so that, because of the uniformity of grinding shavings, there is no need to remove the generated grinding shavings, thereby improving the productivity.

Specifically, the molded body 20 is installed on the rotation shaft 15 that is disposed parallel to the rotation axis of the disk-shaped grindstone 13 disposed on the rotation shaft 12, the grindstone 13 having a diameter of 305 mmφ and a thickness of 19 mm. The molded body 20 is moved forward and backward and fixed at a certain position so that a desired outer diameter (grinding depth) can be obtained after grinding. The grinding depth (grinding thickness) is, for example, about 5 to 200 times, preferably about 10 to 100 times, and more preferably about 15 to 50 times as large as the median particle size of the powdery activated carbon. If the grinding depth is too small, the grinding produces no effects. If the grinding depth is too large, the productivity lowers. In the present invention, the productivity can be improved by producing the molded body having a predetermined thickness larger than a size of a housing in consideration of the grinding depth, in accordance with the size of the housing. Further, generation of grinding shavings by grinding can be suppressed, and moreover the generated grinding shavings may be recycled.

The disk-shaped grindstone may be rotated at a circumferential speed of, for example, about 10 to 35 m/s, preferably about 15 to 32 m/s, and more preferably about 18 to 30 m/s. The rotation shaft for rotating the disk-shaped grindstone may be rotated at a rotational speed of, for example, about 800 to 2200 rpm, preferably about 1000 to 2000 rpm, and more preferably about 1200 to 1800 rpm. In contrast, the rotation shaft for rotating the molded body may be rotated at a rotational speed of, for example, about 200 to 500 rpm and preferably about 300 to 450 rpm. If the circumferential speed (rotational speed) is too low, the molded body is easily broken by grinding. In contrast, if the circumferential speed is too high, the molded body is easily deformed or broken due to an overhigh centrifugal force.

The speed of the disk-shaped grindstone to be moved along the longitudinal direction of the molded body may be, for example, about 10 to 150 mm/second, preferably about 20 to 120 mm/second, and more preferably about 30 to 100 mm/second. If the moving speed is too low, the productivity lowers. In contrast, if the moving speed is too high, the precision of grinding is lowered due to undulation of the ground surface.

As the grinding stone, a conventional grindstone may be used. Examples of the grindstone include an alumina-series grindstone, a silicon carbide-series grindstone, and a combination of an alumina-series grindstone and a silicon carbide-series grindstone. The grindstone contains an abrasive grain having a size (or a grain size) of, for example, about 30 to 600 μm, preferably about 40 to 300 μm, and more preferably about 45 to 180 μm. If the abrasive grain is too coarse, the granular activated carbon easily falls off from the ground surface. In contrast, if the abrasive grain is too fine, it takes a prolonged time for grinding, which tends to lower the productivity.

The grindstone and the molded body may be formed to be relatively movable toward or away from each other. The grindstone and the molded body may be formed so that at least one of the grindstone and the molded body may be movable forward and backward.

The grindstone and the molded body may be attached to shafts that are parallel to each other, respectively. At least one of the grindstone and the molded body may be formed to be movable (relatively movable) in the axial direction.

The grinding step is not limited to the above-mentioned method using a grinding machine. For example, the molded body fixed to the rotation shaft may be ground by a fixed plate-shaped grindstone. In this method, since the generated grinding shavings tend to accumulate on the ground surface, the grinding with air blowing is effective.

The adsorption filter of the present embodiment is used, for example, as a water-purifying filter or the like. When the adsorption filter is used as a water-purifying filter, the water-purifying filter may be obtained, for example, by producing the adsorption filter of the present embodiment according to the above-described production method, then neatening and drying the adsorption filter, and thereafter cutting the adsorption filter into a desired size and shape. The adsorption filter may be compressed on a workbench in order to neaten the shape of the filter; however, if the adsorption filter is compressed too much, the surface of the activated carbon molded body may be consolidated, so that the compression is preferably carried out to a minimum extent. Further as necessary, a cap may be installed on the tip end part, or a nonwoven fabric may be installed on the surface.

The adsorption filter of the present embodiment can be used as a cartridge for water purification by filling a housing therewith. The cartridge is mounted in a water purifier to be subjected to water passing. As a water-passing method, a total filtration method in which a whole amount of raw water is filtered or a circulation filtration method is adopted. In the present embodiment, the cartridge mounted in the water purifier may be used, for example, by filling a housing with the water-purifying filter; however, the cartridge may be used by being further combined with known nonwoven fabric filters, various kinds of adsorption materials, mineral additive materials, ceramic filtering materials, and the like.

The adsorption filter of the present embodiment obtained in the above-described manner is used typically at a space velocity (SV) of 200 to 2000/hr. Also, the adsorption filter has an initial turbidity removal ratio of preferably less than 65% under a condition of a space velocity (SV) of 200/hr or more and 1000/hr or less. The initial turbidity removal capability is more preferably less than 55% and still more preferably less than 45%. Further, the adsorption filter has a free residual chlorine filtration capability of preferably 60 L or more per 1 cc of a cartridge when the space velocity (SV) is larger than 1000/hr and is 2000/hr or less. The free residual chlorine filtration capability is more preferably 80 L or more and still more preferably 100 L or more.

The present specification discloses techniques of various modes as described above, among which principal techniques will be summed up as follows.

That is, an adsorption filter according to one aspect of the present invention includes activated carbon and a fibrillated fibrous binder, wherein the activated carbon has a 0% particle diameter (D0) of 10 μm or more in a volume-based cumulative particle-size distribution and has a 50% particle diameter (D50) of 90 to 200 μm in the volume-based cumulative particle-size distribution; the fibrillated fibrous binder has a CSF value of 10 to 150 mL; and the adsorption filter includes 4 to 8 parts by mass of the fibrillated fibrous binder relative to 100 parts by mass of the activated carbon.

Such a configuration can provide an adsorption filter having an excellent water-passing property and high adsorption performance, in particular, having excellent filtration capability to remove free residual chlorine, agricultural chemicals, and mold odors, as well as having difficulty in causing clogging and having low resistance. Further, the filter has improved strength, suppresses an increase in pressure loss, and is excellent in productivity as well.

In the aforementioned adsorption filter, it is preferable that the activated carbon has a 50% particle diameter (D50) of 100 to 180 μm in the volume-based cumulative particle-size distribution. This produces the above-described effect with more certainty.

In the aforementioned adsorption filter, it is preferable that the activated carbon has a benzene adsorption amount of 25 to 60% by mass. This is considered to allow that an adsorption filter having more excellent adsorption performance can be obtained.

In the aforementioned adsorption filter, it is preferable that the adsorption filter has an initial turbidity removal ratio of less than 65% under a condition of a space velocity (SV) of 200/hr or more and 1000/hr or less.

In the aforementioned adsorption filter, it is preferable that the adsorption filter has a free residual chlorine filtration capability of 60 L or more per 1 cc of a cartridge when the space velocity (SV) is larger than 1000/hr and is 2000/hr or less.

### Examples

Hereafter, the present invention will be more specifically described by way of Examples; however, the present invention is by no means limited to Examples. Values of physical properties in Examples were measured by the following methods.

[Particle Diameter of Granular Activated Carbon]

A 0% particle diameter (D0) in a volume-based cumulative particle-size distribution and a 50% particle diameter (D50) in the volume-based cumulative particle-size distribution were measured by laser diffraction/scattering method using a wet particle size distribution measuring apparatus (“MICROTRAC MT3000EX II” manufactured by Nikkiso Co., Ltd.). A specific method for measuring the particle size distribution will be shown below.

### (Dispersion Liquid Preparation Method)

With ion-exchange water, polyoxyethylene(10) octylphenyl ether (manufactured by Wako Pure Chemical Industries, Ltd.) was diluted 50 times so as to prepare a dispersion liquid for measurement.

### (Sample Liquid Preparation Method)

An amount attaining a transmittance ratio (TR) of 0.880 to 0.900 was weighed into a beaker, and 1.0 ml of the dispersion liquid was added. After stirring with a spatula, about 5 ml of ultrapure water was added and mixed so as to prepare a sample liquid.

A whole amount of the resulting sample liquid was poured into the apparatus, and analysis was made under the following conditions.

### (Analysis Conditions)

Measurement times; average value of three times
Measurement time; 30 seconds
Distribution representation; volume
Particle diameter division; standard
Calculation mode; MT3000II
Solvent name; WATER
Measurement upper limit; 2000 μm, measurement lower limit; 0.021 μm
Residual fraction ratio; 0.00
Passing fraction ratio; 0.00
Residual fraction ratio setting; invalid
Particle transmittance; absorption
Particle refractive index; N/A
Particle shape; N/A
Solvent refractive index; 1.333
DV value; 0.0882

### Transmittance (TR); 0.880 to 0.900

Extension filter; invalid
Flow rate; 70%
Supersonic wave output; 40 W
Supersonic wave time; 180 seconds

[Filter Molded Body Density (g/ml)]

After a resulting cylindrical filter was dried at 120° C. for two hours, the molded body density (g/ml) was determined based on the measured weight (g) and the volume (ml).

[Initial Resistance to Passing Water]

A resistance to water passing through an adsorption filter was measured after 10 minutes had passed from the start of passing water through the adsorption filter at a space velocity (SV) of 1000/hr, that is, at a water passing rate of 1 liter/minute. Samples having an initial resistance to passing water of 0.03 MPa or less were determined as having a passing grade. In Example 9 described later, a resistance to passing water was measured after 10 minutes had passed from the start of passing water at a space velocity (SV) of 1200/hr, that is, at a water passing rate of 1.2 liter/minute. In Examples 10 and 12, a resistance to passing water was measured after 10 minutes had passed from the start of passing water at a space velocity (SV) of 1500/hr, that is, at a water passing rate of 1.5 liter/minute. In Example 11, a resistance to passing water was measured after 10 minutes had passed from the start of passing water at a space velocity (SV) of 2000/hr, that is, at a water passing rate of 2.0 liter/minute.

[Crushing Strength]

A crushing strength was measured by applying pressure to a cylindrical filter at a speed of 2 mm/minute in the lengthwise direction (longitudinal direction) and in the outer circumferential direction (lateral direction) of the cylindrical filter using a tensile and compression testing machine (“TENSILON RTC-1210A” manufactured by Orientec Co., Ltd.). Samples having a longitudinal crushing strength of 200 N or more and having a lateral crushing strength of 80 N or more were determined as having a passing grade.

[Free Residual Chlorine Filtration Capability]

With respect to free residual chlorine filtration capability, an 80% breakthrough life was measured when water was passed at a space velocity (SV) of 1000/hr, that is, at a water passing rate of 1 liter/minute in accordance with JIS S3201 (2010) (raw water concentration of 2.0 mg/L). In Example 9 described later, the filtration capability was measured at a space velocity (SV) of 1200/hr, that is, at a water passing rate of 1.2 liter/minute. In Examples 10 and 12, the filtration capability was measured at a space velocity (SV) of 1500/hr, that is, at a water passing rate of 1.5 liter/minute. In Example 11, the filtration capability was measured at a space velocity (SV) of 2000/hr, that is, at a water passing rate of 2.0 liter/minute. Samples having a free residual chlorine filtration capability of 60 L/cc or more were determined as having a passing grade.

[Turbidity Filtration Capability]

With respect to turbidity component removal performance, a ratio to remove turbidity components was measured after 10 minutes had passed from the start of passing water in accordance with JIS S 3201 (2010), provided that, the test was carried out by setting an initial space velocity (SV) of 1000/hr, that is, a water passing rate of 1 liter/minute, and adjusting the water passing rate so as to attain the dynamic water pressure at the initial water-passing state after the setting. In Example 9 described later, the initial removal ratio was measured at a space velocity (SV) of 1200/hr, that is, at a water passing rate of 1.2 liter/minute. In Examples 10 and 12, the initial removal ratio was measured at a space velocity (SV) of 1500/hr, that is, at a water flow rate of 1.5 liter/minute. In Example 11, the initial removal ratio was measured at a space velocity (SV) of 2000/hr, that is, at a water passing rate of 2.0 liter/minute.

A clogging life was measured until the flow rate decreased to half of the initial flow rate in each sample (raw water turbidity of 2.0 degrees).

[Specific Surface Area]

A nitrogen adsorption isothermal curve was measured at 77K of the activated carbon using BELSORP-28SA manufactured by BEL JAPAN, INC. From the obtained adsorption isothermal curve, analysis by multiple-point method was carried out in accordance with a BET equation, and the specific surface area was calculated from a straight line in a region of a relative pressure p/p0 of 0.001 to 0.1 of the obtained curve.

[Raw Material]

(Granular Activated Carbon)

A method for producing granular activated carbon will be described; however, the method is not particularly limited as long as the required physical properties are satisfied.

Coconut shell char carbonized at 400 to 600° C. was activated with water vapor at 900 to 950° C., and the activation time was adjusted so as to attain an intended benzene adsorption amount. The resulting coconut shell activated carbon was washed with dilute hydrochloric acid and desalted with ion-exchange water so as to obtain granular activated carbon A (10×32 mesh, benzene adsorption amount of 30.5 wt %, specific surface area of 1094 m²/g).

(Activated Carbon)

Powdery activated carbon sample 1: coconut shell raw material

Powdery activated carbon sample 2: coconut shell raw material

Powdery activated carbon sample 3: coconut shell raw material

Powdery activated carbon sample 4: coconut shell raw material

Powdery activated carbon sample 5: coconut shell raw material

Powdery activated carbon sample 6: coconut shell raw material

Powdery activated carbon sample 7: coconut shell raw material

Powdery activated carbon sample 8: coconut shell raw material

The D0, D50, and Bz adsorption amount of each activated carbon particle are as shown in the following Table 1. Also, a method for preparing each activated carbon is as follows.

(Activated Carbon Samples 1 to 3)

The granular activated carbon A was ground with a ball mill so as to attain a D50 value of 20 μm in the activated carbon sample 1, a D50 value of 90 μm in the activated carbon sample 2, and a D50 value of 110 μm in the activated carbon sample 3. With use of a dry classification apparatus, the fine powder was removed, and a predetermined value of D0 was obtained.

(Activated Carbon Sample 4)

The granular activated carbon A was ground with a ball mill so as to attain a D50 value of 20 μm in the activated carbon sample 4, where the fine powder was not removed.

(Activated Carbon Samples 5 to 8)

The granular activated carbon A was ground with a roll mill so as to attain a D50 value of 150 μm in the activated carbon sample 5, a D50 value of 170 μm in the activated carbon sample 6, a D50 value of 190 μm in the activated carbon sample 7, and a D50 value of 220 μm in the activated carbon sample 8. With use of a vibration sieve, the fine particles and the fine powder were removed, and a predetermined value of D0 was obtained.

(Binder Raw Material)

Binder 1: Acrylic-fibrous binder having a CSF value of 92 to 120 ml

Binder 2: Cellulose-fibrous binder having a CSF value of 30 ml or less

<Production of Adsorption Filters of Examples 1 to 12 and Comparative Examples 1 to 6>

In each of Examples 1 to 12 and Comparative Examples 1 to 6, a fibrous binder having a CSF value adjusted with an acrylic-fibrous binder and a cellulose-fibrous binder was put in a sum of 1.2 kg in parts by mass shown in the following Table 1 with respect to 100 parts by mass of a activated carbon sample shown in the following Table 1, and tap water was added to attain a slurry amount of 20 liters.

With respect to the binder, the slurry was prepared by containing only the acrylic-fibrous binder in each of Examples 1 to 3 and 6 to 12 and Comparative Examples 1 to 6, and by containing a mixture of the acrylic-fibrous binder and the cellulose-fibrous binder in Examples 4 to 5.

A forming die depicted in FIG. 1 of Japanese Patent No. 3516811 (a tubular die having a large number of small suction holes) was provided. The forming die had an outer diameter of 40 mmφ, a shaft diameter of 12 mmφ, and an inter-flange distance of 180 mm. A cylindrical nonwoven fabric was installed on the die. The die was placed into the slurry, and the slurry was filtered on the die by suction to give a molded body so that the molded body had an outer diameter of 40 mmφ, followed by drying. The resulting molded body was installed on an automatic grinding machine shown in FIG. 1, and an outer surface of the molded body was ground at a rotation speed of the molded body of 300 rpm, a rotation speed of the grindstone of 1200 rpm, and a moving speed of the grindstone of 300 mm/10 seconds (3 cm/second) to give a molded body having an outer diameter of 40 mmφ, an inner diameter of 12 mmφ, and a height of 180 mm. Thereafter, the molded body was further cut to prepare a molded body having an outer diameter of 40 mmφ, an inner diameter of 12 mmφ, and a height of 54 mm. The resulting molded body had a volume of 60.4 ml. The outer circumferential part of this molded body was wrapped with a single layer of a spunbonded nonwoven fabric to give a test adsorption filter.

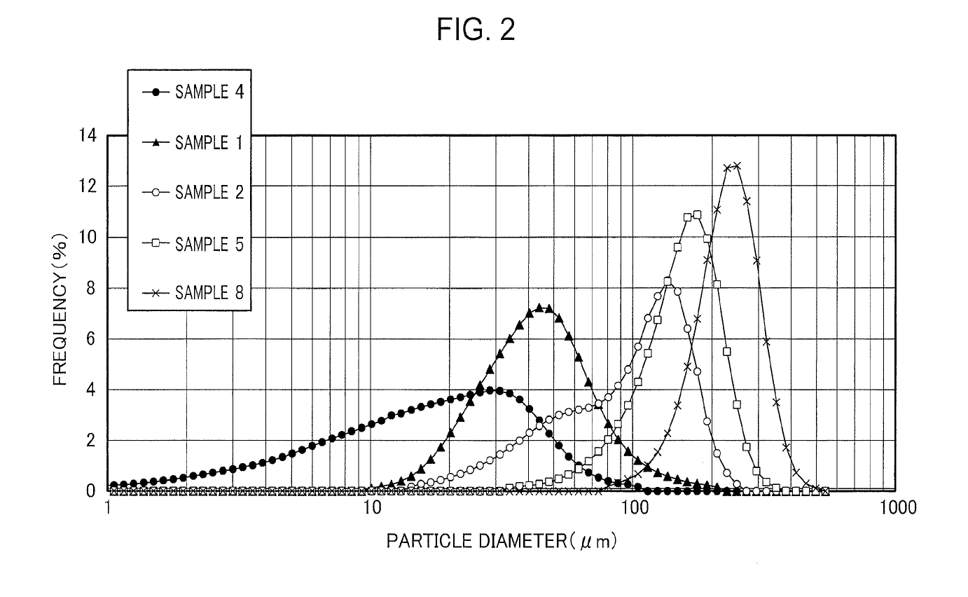

The above-described evaluation test was carried out on this adsorption filter, and the results are shown in Table 1. Also, graphs showing particle size distributions of principal activated carbon samples in Examples and Comparative Examples are shown in FIG. 2.

TABLE 1

| | | | | | | | | | | Initial | Crushing | | Free | | |
|---|---|---|---|---|---|---|---|---|---|---|---|---|---|---|---|
| | Activated carbon | | | | Binder | | | Wa- | | resis- | strength | | residual | Turbidity | |
| | | | | Bz ad- | Parts | | Space | ter | Molded | tance | Longi- | Lat- | chlorine | Initial | Clogg- |
| | | | | sorption | by | | veloc- | passing | body | to water | tu- | er- | filtration | remov- | ing |
| | | D0 | D50 | amount | mass | CSF | ity | rate | density | passing | dinal | al | capability | al ratio | life |
| | Name | μm | μm | % | Parts | ml | (SV) | L/min | g/mL | MPa | N | N | L/cc | % | L/cc |
| Example 1 | Sample 2 | 13.1 | 100.2 | 29.7 | 5.0 | 90 | 1000/hr | 1 | 0.398 | 0.010 | 363.0 | 156.5 | 229.5 | 62.1 | 30.0 |
| Example 2 | Sample 3 | 19.1 | 119.0 | 29.8 | 5.0 | 90 | 1000/hr | 1 | 0.369 | 0.006 | 340.0 | 142.0 | 175.0 | 52.0 | >30 |
| Example 3 | Sample 5 | 31.1 | 150.0 | 30.2 | 5.0 | 90 | 1000/hr | 1 | 0.341 | 0.003 | 325.0 | 135.5 | 94.5 | 36.5 | >30 |
| Example 4 | Sample 5 | 31.1 | 150.0 | 30.2 | 5.0 | 52 | 1000/hr | 1 | 0.343 | 0.005 | 304.0 | 120.8 | 96.0 | 38.0 | >30 |
| Example 5 | Sample 5 | 31.1 | 150.0 | 30.2 | 5.0 | 21 | 1000/hr | 1 | 0.345 | 0.007 | 227.3 | 97.5 | 98.1 | 40.8 | >30 |
| Example 6 | Sample 5 | 31.1 | 150.0 | 30.2 | 8.0 | 90 | 1000/hr | 1 | 0.315 | 0.002 | 475.0 | 200.0 | 63.0 | 34.8 | >30 |
| Example 7 | Sample 6 | 42.0 | 169.0 | 29.8 | 5.0 | 90 | 1000/hr | 1 | 0.340 | 0.002 | 320.0 | 133.0 | 77.0 | 32.0 | >30 |
| Example 8 | Sample 7 | 55.0 | 191.0 | 29.8 | 5.0 | 90 | 1000/hr | 1 | 0.360 | 0.002 | 330.0 | 143.0 | 62.0 | 28.0 | >30 |
| Example 9 | Sample 2 | 13.1 | 100.2 | 29.7 | 5.0 | 90 | 1200/hr | 1.2 | 0.398 | 0.012 | 363.0 | 156.5 | 203.4 | 60.8 | >30 |
| Example 10 | Sample 2 | 13.1 | 100.2 | 29.7 | 5.0 | 90 | 1500/hr | 1.5 | 0.398 | 0.015 | 363.0 | 156.5 | 190.7 | 59.7 | >30 |
| Example 11 | Sample 2 | 13.1 | 100.2 | 29.7 | 5.0 | 90 | 2000/hr | 2 | 0.398 | 0.020 | 363.0 | 156.5 | 140.2 | 56.2 | >30 |
| Example 12 | Sample 3 | 19.1 | 119.0 | 29.8 | 5.0 | 90 | 1500/hr | 1.5 | 0.369 | 0.012 | 340.0 | 142.0 | 128.0 | 48.5 | >30 |
| Comparative | Sample 4 | 0.5 | 16.5 | 29.8 | 5.0 | 90 | 1000/hr | 1 | No measurement because of not being | | | | | | |
| Example 1 | | | | | | | | | subjected to suction molding. | | | | | | |
| Comparative | Sample 1 | 9.3 | 41.2 | 31.1 | 5.0 | 90 | 1000/hr | 1 | 0.391 | 0.029 | 336.0 | 128.5 | 452.0 | 94.4 | 12.2 |
| Example 2 | | | | | | | | | | | | | | | |
| Comparative | Sample 8 | 74.0 | 221.6 | 27.4 | 5.0 | 90 | 1000/hr | 1 | 0.378 | 0.003 | 387.5 | 163.5 | 31.8 | 22.2 | >30 |
| Example 3 | | | | | | | | | | | | | | | |
| Comparative | Sample 5 | 31.1 | 150.0 | 30.2 | 3.0 | 90 | 1000/hr | 1 | 0.355 | 0.006 | 190.0 | 78.0 | 102.5 | 38.0 | >30 |
| Example 4 | | | | | | | | | | | | | | | |
| Comparative | Sample 5 | 31.1 | 150.0 | 30.2 | 10.0 | 90 | 1000/hr | 1 | 0.295 | 0.001 | 397.0 | 168.0 | 55.0 | 32.5 | >30 |
| Example 5 | | | | | | | | | | | | | | | |

| | | | | | | | | | | | | | |
|---|---|---|---|---|---|---|---|---|---|---|---|---|---|
| Comparative | Sample 5 | 31.1 | 150.0 | 30.2 | 5.0 | 7 | 1000/hr | 1 | 0.345 | >0.100 | 130.0 | 38.0 | No measurement because |
| Example 6 | | | | | | | | | | | | | of being crushed at an initial |
| | | | | | | | | | | | | | stage of water passing. |

<Considerations>

As shown in Table 1, it was found out that all of the adsorption filters according to Examples had low resistance, were excellent in strength, and were excellent in free residual chlorine filtration capability. Further, clogging hardly occurred, and the life of the filter was excellent. In particular, in Examples 2 to 6 in which the D50 of the activated carbon was within a range of 110 to 150 μm, the adsorption filters had sufficient strength, had high free residual chlorine filtration capability, and were excellent in clogging life as well.

From the results of Examples 9 to 12, it was found out that, particularly when the D50 of the activated carbon was within a range of 90 to 120 μm, the free residual chlorine filtration capability was maintained at a high level even when the SV was larger than 1000/hr.

Contrary to the results of Examples pertaining to the present invention, in Comparative Example 1 using activated carbon in which the D0 of the activated carbon was considerably smaller than the range of the D0 of the present invention, it was impossible to carry out the suction molding. Further, in Comparative Example 2 using activated carbon in which the D50 of the activated carbon was smaller than the range of the D50 of the present invention though the D0 of the activated carbon was larger than the D0 of Comparative Example 1, the turbidity removal ratio was high, and clogging occurred at an early stage. Conversely, in Comparative Example 3 using activated carbon in which the D50 of the activated carbon was larger than the range of the D50 of the present invention, the adsorption filter was poor in dechlorination performance.

Meanwhile, in Comparative Example 4 in which the amount of the binder was small, sufficient strength was not obtained. In Comparative Example 5 in which the amount of the binder was excessively large, the free residual chlorine filtration capability was not sufficient. Further, in Comparative Example 6 using a binder having a small CSF value, the resistance was large, and the adsorption filter was poor in strength, so that the adsorption filter crushed at an initial stage of water passing.

This application is based on Japanese Patent Application No. 2014-234155 filed on Nov. 19, 2014, the entire contents of which are incorporated herein.

The present invention has been suitably and fully described by way of embodiments with reference to the drawings or the like in the above description so as to express the present invention; however, it should be recognized that those skilled in the art can easily change and/or improve the above-described embodiments. Therefore, it is interpreted that, unless the changes and modifications made by those skilled in the art are at a level that departs from the scope of the rights of the claims, those changes and modifications are all encompassed within the scope of the rights of the claims.

### INDUSTRIAL APPLICABILITY

The present invention has a wide range of industrial applicability in the technical field of adsorption filters that are used for removing harmful substances and the like.

1. An adsorption filter comprising activated carbon and a fibrillated fibrous binder,
wherein
the activated carbon has a 0% particle diameter (D0) of 10 μm or more in a volume-based cumulative particle-size distribution and has a 50% particle diameter (D50) of 90 to 200 μm in the volume-based cumulative particle-size distribution;
the fibrillated fibrous binder has a CSF value of 10 to 150 mL; and
the adsorption filter comprises 4 to 8 parts by mass of the fibrillated fibrous binder relative to 100 parts by mass of the activated carbon.

2. The adsorption filter according to claim 1, wherein the activated carbon has a 50% particle diameter (D50) of 100 to 180 μm in the volume-based cumulative particle-size distribution.

3. The adsorption filter according to claim 1, wherein the activated carbon has a benzene adsorption amount of 25 to 60% by mass.

4. The adsorption filter according to claim 1, wherein the adsorption filter has an initial turbidity removal ratio of less than 65% under a condition of a space velocity (SV) of 200/hr or more and 1000/hr or less.

5. The adsorption filter according to claim 1, wherein the adsorption filter has a free residual chlorine filtration capability of 60 L or more per 1 cc of a cartridge when the space velocity (SV) is larger than 1000/hr and is 2000/hr or less.
